(19) United States
(12) Patent Application Publication
(10) Pub. No.: US 2015/0127391 A1
(43) Pub. Date: May 7, 2015

(54) COMPREHENSIVE CARBON FOOTPRINT DETERMINATION AND OFFSET FOR MULTI-POINT, MULTI-MODAL, MIXED ACTIVITY TRAVEL

(71) Applicant: VITA TRAVEL AGENT CORPORATION, Santa Barbara, CA (US)

(72) Inventor: Gregory M. BELLOWE, Santa Barbara, CA (US)

(73) Assignee: VITA TRAVEL AGENT CORPORATION, Santa Barbara, CA (US)

(21) Appl. No.: 14/073,527

(22) Filed: Nov. 6, 2013

(51) Int. Cl. G06Q 20/14; G06Q 10/00; G06Q 10/02

(52) U.S. Cl. CPC G06Q 20/145; G06Q 10/02; G06Q 10/30
USPC 705/5

(57) ABSTRACT

There is much concern about global warming of the Earth caused by increasing concentrations of greenhouse gases produced by human activities such as the burning of fossil fuels and deforestation. There is also concern water and air pollution that are a byproduct of human activities. The invention comprises a method and system that quantifies and provides feedback regarding an environmental impact of all planned or completed activities associated with an entire trip including the impact of transportation, hotel, restaurants, and recreational activities. It further allows the traveler to offset the negative environmental impact by paying a corresponding amount of money to an organization associated with improving the environment.

### BACKGROUND OF THE INVENTION

1. Technical Field

The invention relates to determining a carbon footprint for a variety of types of trip-related activities. More particularly, the invention relates to a method and system for an overall carbon impact and corresponding offset for particular entire trip itinerary.

2. Description of the Prior Art

A carbon impact of an activity, also referred to as the activity's carbon footprint, refers to the amount of CO₂ gas that is emitted into the Earth's atmosphere as a byproduct of the activity. To assess an overall carbon impact for a set of activities, at least two aspects must be determined: what the activity is and how much carbon did the activity produce. Once an activity is identified, then steps may be taken to assess the carbon impact of that activity.

Regarding determining the carbon impact of a trip-related activity, data is being collected and made available regarding the amount of carbon emissions produced by various transportation options such as automobiles, busses, subway, trains, airplanes, and cruise ships. Some data is also collected about lodging stays. Such emissions data may be expressed in units of tons of CO₂ emissions per mile per person. Applications are now evolving that make use of this data for allowing commuters and travelers to lessen their carbon impact by choosing modes of transportation or routes that emit less carbon or pay a carbon offset fee to counter the carbon impact.

With cap and trade policies under discussion, there is a need to be able to quantify the carbon impact of various activities and to assign a monetary value to such impact. A carbon offset fee may fund organizations that create, finance, run, and/or market projects that aim to reduce greenhouse gas (GHG) emissions. One example of such a project is one that plants trees. For another example, several projects exist that collect biogas and burn it instead of burning fossil fuels to create electricity for export to the regional power grid via an interconnection with the local electric power distribution utility to generate electricity. Other projects may include buying up forested land for preservation or occupied land for clearing and planting (unpaving paradise).

Most applications use published carbon emissions data to determine a carbon footprint for transportation. That is, known applications are limited to determining a route and mode of transportation for getting from point A to point B with the smallest carbon footprint.

Carbon calculators are available on certain travel-related websites, such as United.com. FIG. 1 shows the result of using United's Carbon Offset Program in which a traveler enters the number of passengers, the month of the year and the set of cities visited. United's calculator determines a carbon offset only for that flight itinerary, and the website presents options for where to pay the offset amount. In the example shown in FIG. 1, 2 passengers travel from San Jose to Boston, creating 1.21 metric tons of CO₂. The traveler has opted to contribute $22.42 to Forest Conservation of California to offset the carbon impact of the flight. However, to determine an offset for an entire trip itinerary, separate calculators would need to be used for each individual trip event such as for hotels, meals, and activities.

Other carbon calculators available through the Internet such as myfootprint.org are directed at determining the carbon footprint of a household over a year's time. The inputs are household, not travel-related, and are not constrained to a particular start date and end date such as with a trip.

Certain tour operators build in the carbon impact offset in the price of their services. Such a tour is carbon neutral because the cost of offsetting the carbon emissions is included in the price of the tour. However, the portion of the overall cost used as an offset may not be visible to the traveler, and may only offset the portions of trip included in the tour cost. For example, flying to and from a point of departure/arrival may not be offset if the tour does not include the airfare.

### SUMMARY OF THE INVENTION

There is much concern about environmental degradation and the impact by humans on the environment including water pollution, air pollution, land pollution, and global warming of the Earth caused by increasing concentrations of greenhouse gases produced by human activities such as the burning of fossil fuels and deforestation. Greenhouse gases typically include carbon dioxide (CO₂) and methane (CH4). The invention comprises a method and system that allows a traveler to receive feedback regarding the total adverse effect on the environment of all planned or completed activities associated with an entire trip including the impact of types of activities such as transportation, lodging, restaurants, and activities. It further allows the traveler to offset the trip's adverse impact by donating a dollar amount to an organization associated with improving the environment in ways that work to overcome the adverse effects. For example, the method and system may provide a traveler feedback on the carbon impact associated with a trip, and allow donating money to environmental organizations that work to directly to remove the CO₂ emitted as a result of the trip, such as funding the Nature Conservancy's work to plant trees or to indirectly avoid the emission of CO₂ by investing in alternative energy sources such as windmill or solar farms.

### BRIEF DESCRIPTION OF THE DRAWINGS

FIG. 1 is an example screenshot of a website providing carbon footprint information and accepting monetary carbon offsets for air transportation.

FIG. 2 is a block diagram of components of the system, according to an embodiment of the invention;

FIG. 3 is a screen shot of a web page for purchasing carbon offsets, according to an embodiment of the invention.

FIG. 4 shows at least a partial list of companies that certify trip-related services for sustainability, according to an embodiment of the invention.

FIG. 5 is a table of example carbon emissions provided by various sources across different trip-related services, according to an embodiment of the invention.

FIG. 6 shows a main page for a Trip Planner, according to an embodiment of the invention.

FIG. 7 shows more itinerary events in the itinerary tab, according to an embodiment of the invention.

FIG. 8 shows example contents of the offset tab, according to an embodiment of the invention.

FIG. 9 shows example contents of the offset tab after calculating the carbon offsets, according to an embodiment of the invention.

FIG. 10 shows an example screenshot showing the totals for the units of carbon offsets required to offset all activities of the entire trip, according to an embodiment of the invention.

FIG. 11 is a block diagram that illustrates a computer system 1100 upon which an embodiment of the invention may be implemented.

FIG. 12a-d are example screen shots of mobile device applications that may facilitate identifying and recording location, according to an embodiment of the invention.

FIG. 13 is a flow diagram showing the process of offsetting the environmental impact of trip, according to an embodiment of the invention.

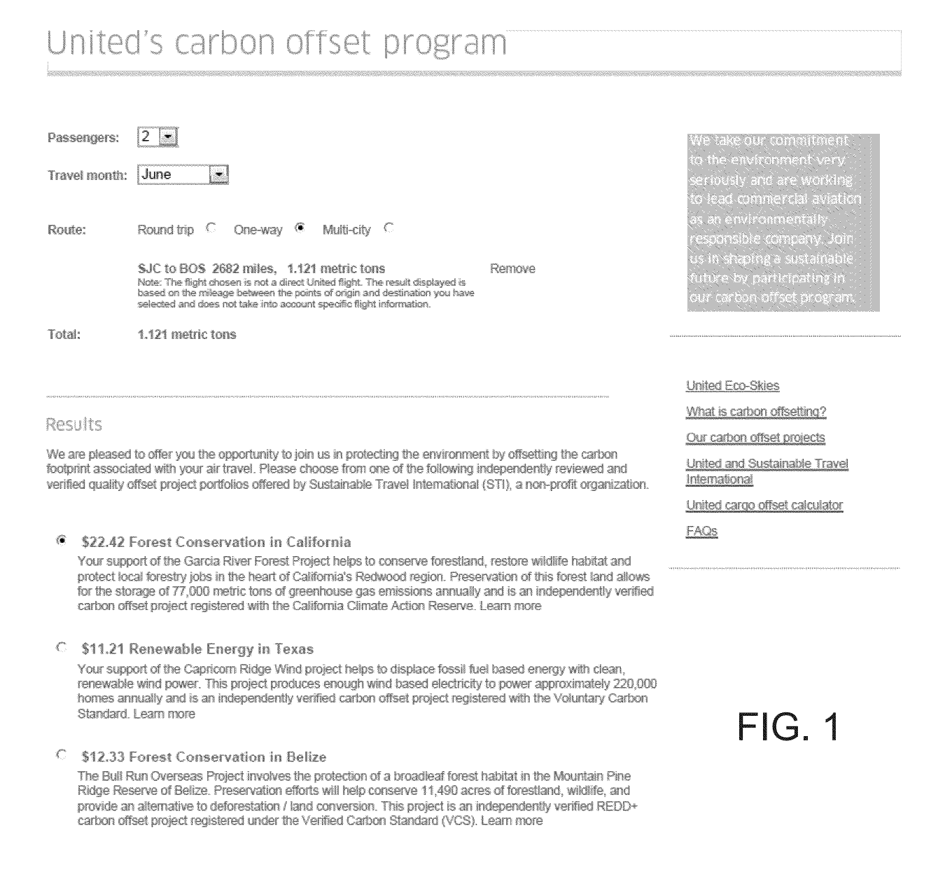

### DETAILED DESCRIPTION OF THE INVENTION

The invention comprises a method and system that receive trip information including a plurality of trip events types such as transportation, lodging, meals, and other work or recreational activities, determine an estimated total environmental impact for the entire trip, such as a carbon footprint, and facilitate the payment of an offset, such as a carbon offset.

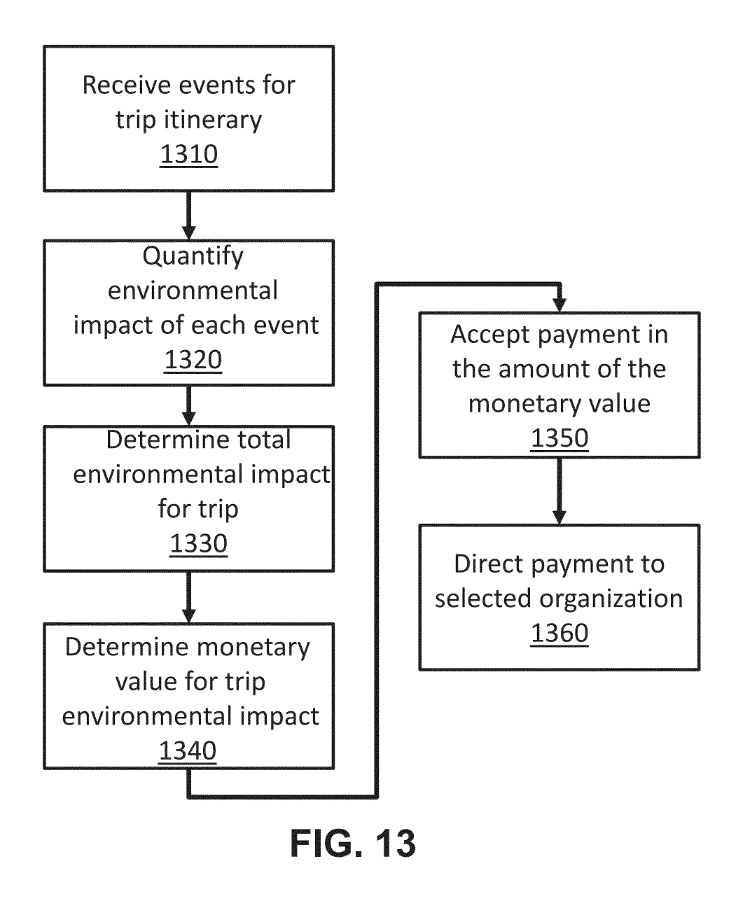

FIG. 13 is a flow diagram that provides an overview of the process for offsetting the environmental impact of a trip. In Step 1310, one or more events is received to be included in an itinerary for a trip. In Step 1320, the environmental impact of each event in the itinerary is quantified. The total environmental impact for the entire trip is determined in Step 1330, and the total trip environmental impact includes the impact of all events that were quantified in Step 1320. A monetary value is assessed for the total trip environmental impact in Step 1340, and in Step 1350, payment in the amount of the assessed monetary value is received. In Step 1360, the received payment is sent to a selected organization whose function/purpose is to ameliorate the environmental impact. The organizations may be non-profit organizations, governmental organizations, or any other kind of organization. Examples of function/purpose to ameliorate environmental impact may include planting trees, lobbying for environmental protection, buying open space as a preserve, etc.

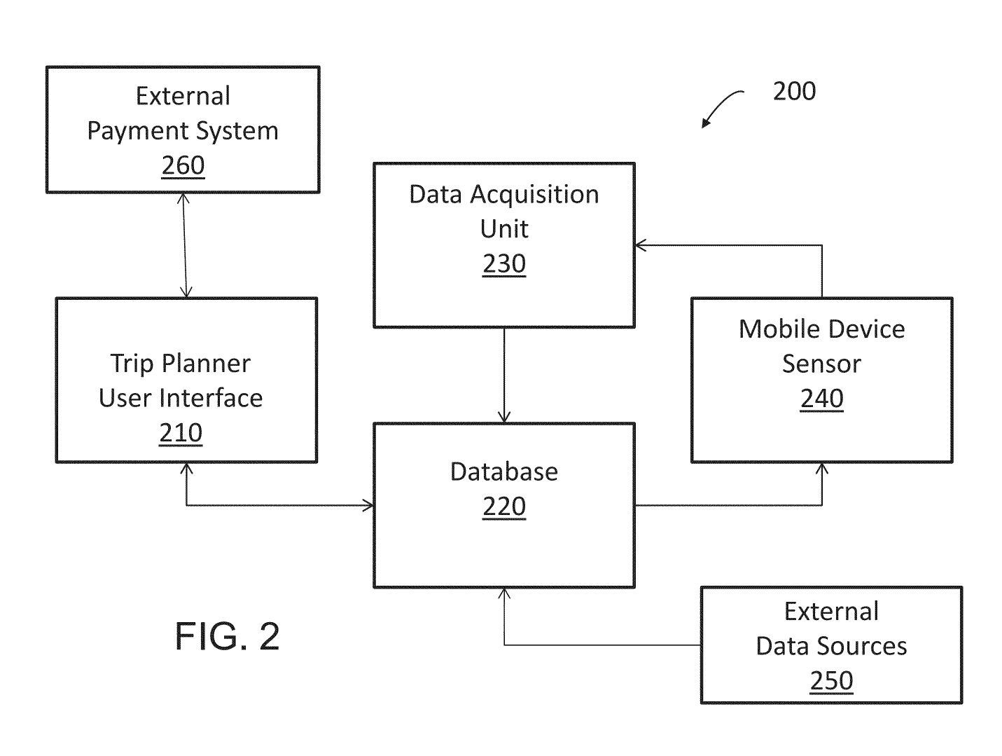

FIG. 2 is a block diagram of components of the system, according to an embodiment of the invention. System 200 shown in FIG. 2 comprises components: Trip Planner User Interface 210, Database 220, Data Acquisition Unit 230, Mobile Device Sensor and Interface 240, External Payment System 260, and External Data Sources 250. These components may each provide different capabilities in each distinct embodiment of the invention as described below.

Regarding terminology used herein, a “trip” is a well-defined sequence of activities with a known start location, optionally a start date, optionally a start time, a known end location, optionally an end date, and optionally an end time. A traveler is one who plans and takes a trip, although a person of ordinary skill in the art could imagine that a trip planner may be different than the person actually taking the trip, such as a travel agent or administrative assistant planning a business trip. We assume for simplicity herein, that the planner and the traveler are the same person, though the invention is not so limited. As such, the traveler is considered to be the user of the trip planning system.

Although the trip planning tool may be used to measure environmental impact such as depletion of the availability of potable water, air pollution such as smoke, ozone depletion, or contributions to a landfill, the following sections describe a particular example of measuring a carbon footprint. Similarly, once a dollar value is estimated for a total adverse impact on the environment, the money may be invested in a wide variety of environmental non-profit organizations (such as the Sierra Club, World Wildlife Fund, or Ocean Conservancy) in addition to those organizations directly or indirectly for reducing greenhouse gasses in the atmosphere.

### Trip Planner User Interface 210:

The trip planner user interface is an interactive portion of the trip planning application that allows a traveler to see where he/she is on a digital map through geo-location of a device, see travel related business/events/monuments around his/her current geo-location, plan a trip, see travel related businesses/events/monuments added to his/her trip, receive impact information about a trip, and pay to offset that impact. In an embodiment of the invention, the trip planner provides trip planning services for finding and selecting trip events including transportation, lodging, meals, single day recreational experiences, and multi-day experiences at one or more destinations. A trip event comprises a single line item in a trip itinerary. Similar to other travel planning sites such as Travelocity, Orbitz, or Expedia, the trip planner may provide information regarding choices of hotels, restaurants, and local activities at a destination. Similar to other trip planning sites such as mapquest.com, Google maps, or regional mass transportation sites such as 511.org, the trip planner user interface may provide information regarding alternative forms of transportation and routes to get from one location to another. However, unlike most other sites, the trip planner user interface may provide ecologically-relevant information (when there is a source for such information) regarding each choice including the carbon footprint associated with each choice as well as general ecological certification ratings for travel-related services.

Using the data in database 220, and external data sources 250, the trip planner 210 may display impact information for each individual trip event of the itinerary including at least the selected transportation, lodging, meals, and work and recreational activities. In another aspect of the invention, a total carbon impact may be determined for the entire itinerary across trip event categories. The total carbon impact may be an estimate for a planned itinerary that may change as events in the itinerary change.

Information about a planned or retrospective itinerary may be entered by the traveler and stored in database 220 for later retrieval and update. The Trip Planner user interface may also be used to update an itinerary during or after the trip. For example, an itinerary may simply specify breakfast as a trip event, and the traveler may provide more specific information about breakfast after choices are made such as the name of the eating establishment (hereinafter “restaurant”), type of restaurant, type of food ordered. Alternatively, an itinerary event may be added or deleted. For example, if the traveler sleeps in and skips breakfast, breakfast may be removed from the itinerary and the expected carbon impact from that breakfast removed from the trip total. Similarly, a traveler who planned to hike one day (having no carbon footprint) may select a visit to a museum instead because of inclement weather. The incremental carbon impact of visiting the museum may be added to the trip total.

After the last trip event for each day is entered into the itinerary, the trip planning tool may automatically add a trip event entry for returning to the ending location for the day, such as returning from the last location visited to the hotel where the traveler is staying for the night.

After the last trip event on the last day of the trip is entered into the itinerary, the trip planning tool may automatically add a trip event entry for returning to the ending location for the trip, such as returning from the last location visited to the home where the traveler lives. Alternatively, the trip planning tool may automatically add a trip event entry for returning to the starting location where the trip began. Alternatively, the trip planning tool may automatically continue to calculate carbon emissions as the traveler continues to travel until the traveler turns off the carbon footprint calculation services.

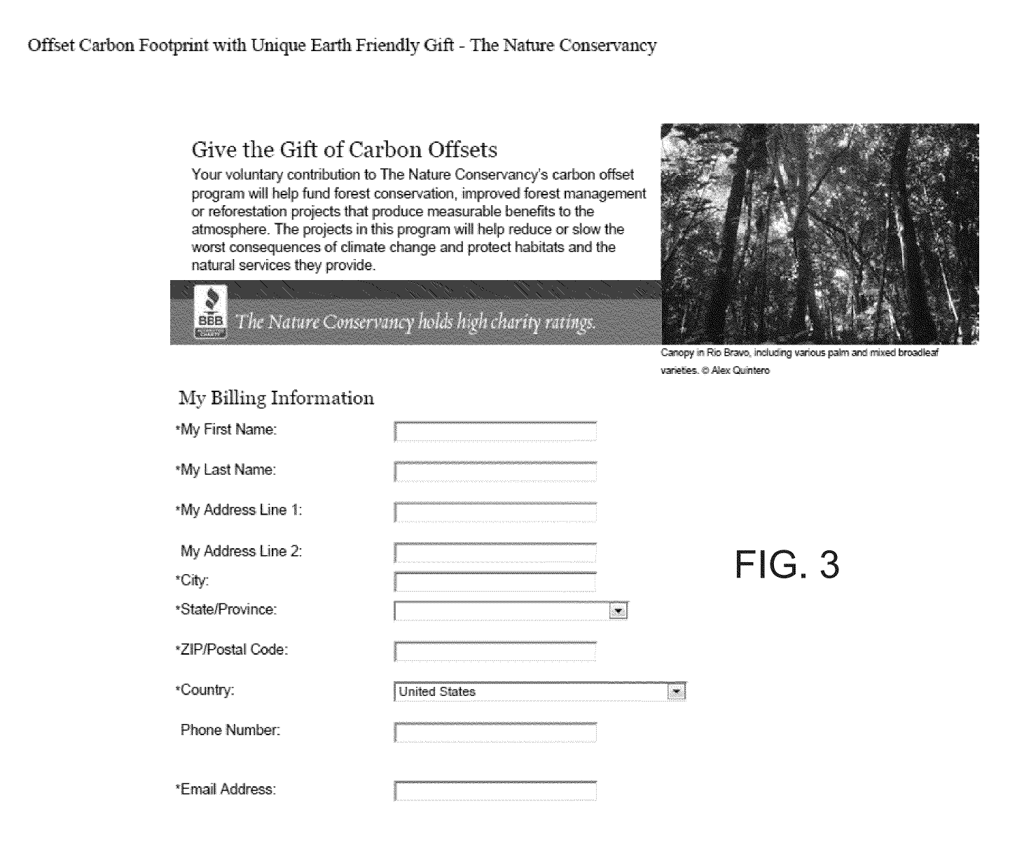

The trip planner may express the carbon impact in terms of mass (weight) of carbon dioxide per person associated with a trip event. Each trip event as well as the total carbon impact for the entire trip may also be displayed as a monetary value (e.g. dollar value) needed to offset the carbon impact of the trip. For example, planting a tree is one way to remove a certain quantity of greenhouse gases. The cost for planting the number of trees necessary to remove the amount of greenhouse gasses emitted as a result of the itinerary may be displayed. Some organizations have websites where donors can choose to offset their carbon footprint. In an embodiment of the invention, the trip planner may offer a direct link to a web site such as The Nature Conservancy (see FIG. 3) that allows donors to offset their carbon footprint by donating to reforestation efforts. In this embodiment, payment processing may be performed by the external website and the trip planner may not have access to the information regarding how much money was donated where unless and until the external website sends this information through a digital interface, email or other means. In an alternate embodiment, the trip planner may offer a list of environmental organizations, allow a traveler to select one or more of such organizations, perform payment processing (though payment processing may be outsourced), keep records of who gave how much to which organizations, and direct the traveler's donation directly to their selected organizations on behalf of the traveler. In another embodiment, rather than directly donating a traveler's money to the selected organization(s) at the time the money is received, the donated money from many travelers may be pooled over a certain period of time, then periodically, an organization may receive the total amount in the pool designated for that organization. The trip planner may keep records about and provide acknowledgements for each individual donation rather than each selected organization tracking each individual traveler's donation.

In an embodiment, the traveler may select among a number of different organizations such as an organization that plants trees or one that facilitates and supports building wind and solar generators, or alternatively the traveler may request that the trip planner distribute the donation to one or more organizations according to where the need is greatest according to the configuration of the trip planner.

Using the trip planning user interface provides a single place to make a one-time single payment for all trip events in a trip, rather than offsetting each transportation event separately from each other and from the other trip event categories. Also, In addition to planning services, the trip planner may be used to determine a retrospective carbon impact of a trip already concluded. Information regarding trip events actually concluded may be entered into the system, and a more accurate carbon impact may be determined and offset.

The trip planning user interface may run on a computer such as a desktop or laptop, but may also be run on a mobile device such as a tablet, mobile phone or other mobile devices such as google glasses. The fundamental features of planning a trip, estimating carbon footprint, determining carbon offsets, and enabling the donation of the offsets may be available on every supported device regardless of the form factor.

Checking into an itinerary event confirms attendance to the event whether pre-planned or not. Checking in can be performed using the trip planner user interface. In an alternate embodiment, a check-in application may be provided independent of the full trip planning user interface on mobile devices or on wearable devices such as watches, eyeglasses, or clothing. The wearable devices may be used to identify location, and a simplified interface for checking in may be used such detecting a voice command, a gesture, or a button tap.

Although payment for offsets is referred to herein as a “donation,” a person of ordinary skill in the art would recognize that the system described herein may also be used for paying for such offsets in exchange for some good, service, or other reward.

Database 220: Database 220 serves as a repository for account and trip information for each traveler. Account data entered through the trip planner user interface may be stored in the database in a traveler's account or used to retrieve itinerary information for a previously planned trip. As travelers interact with the planning tool, itinerary information may be stored. Travelers may also enter completed activity information to make the computed carbon impact for a trip more accurate. However, such activity completed information may also be received from other sources such as from the data acquisition unit 230.

In addition, database 220 may store data regarding potential trip events and their associated carbon impact. Data collected from external sources such as Conservation International, Carbon Fund, or the WebEx Carbon Calculator may be stored in the database and updated over time as new data becomes available or is updated.

The database may be implemented as any type of non-volatile storage with a store and retrieve interface.

Data Acquisition Unit 230: The data acquisition unit 230 may receive data from sensors that provide advisory information regarding the location and/or activities in which the traveler is engaged. An example may be a GPS unit in a traveler's mobile device or car receiving latitude and longitude identifying the location of the device. It may also be possible to gather more fine grained information about the carbon impact of an automobile trip between point A and point B from the car itself, taking into consideration driving speed, starts and stops, and elevation changes to determine and record a person's location over time, which can include information regarding a path taken, speed, and an amount of time in transit.

Applications are emerging for sensing environmental content that can capture information that could be later mined to discover a traveler's participation in an activity. For example, social media applications such as Twitter and Facebook provide a simple interface for a traveler to “check in” and report on a current activity. In an embodiment of the invention, the mobile trip planning user interface may provide such a “check in” feature.

In an embodiment, when the location data stops changing (i.e. no movement) for a threshold amount of time, the data acquisition unit may find activities related to the current location and prompt the traveler to provide updated activity information, if the traveler requests. As mobile devices become more aware of their environmental context through image and signal processing, other contextual clues could be sent to the data acquisition unit such as recognizing that the environment looks like a restaurant, hotel room, forest, amusement park, etc.

Actual information may replace the estimated data in the trip itinerary. Confirmed information such as distance based on GPS input and confirmed inferences based on contextual clues may be added to the itinerary stored in the database 220, replacing estimated data with actual data.

Mobile Device Sensor and Interface 240: The mobile device sensor and interface 240 may provide two functions. First, the display on the mobile device may be used to show the traveler information and to receive traveler input. For example, the traveler may request the system to prompt the traveler for actual activity information at a periodic interval or upon detecting an event. In addition, sensors in the mobile device may send signals to the data acquisition unit.

To obtain actual data, a traveler may authorize information to be collected from mobile phone data records and/or social media to establish where the traveler has been at various times. For example, if a traveler's location happens to coincide with the location of a hotel, the traveler may be prompted to indicate the activity associated with the location such as staying in a room there or eating in a restaurant.

Higher levels of accuracy may be associated with higher cost in terms of technology and traveler involvement. For example, a mobile phone could report location every 15 minutes or a traveler could press a button on a mobile device to cause it to report a current location when arriving at a destination.

External Data Sources 250: In an embodiment, information from external data sources 250 regarding carbon footprint associated with choices for various trip events as well as ecological certification information may be loaded into database 220 in a variety of ways. The data may be manually retrieved from the external source and formatted for the local database. Alternatively, an API may be used to periodically and automatically retrieve the most current external data for updating the local database. In another embodiment, the external sources may be searched on demand in response to a request for trip event options information.

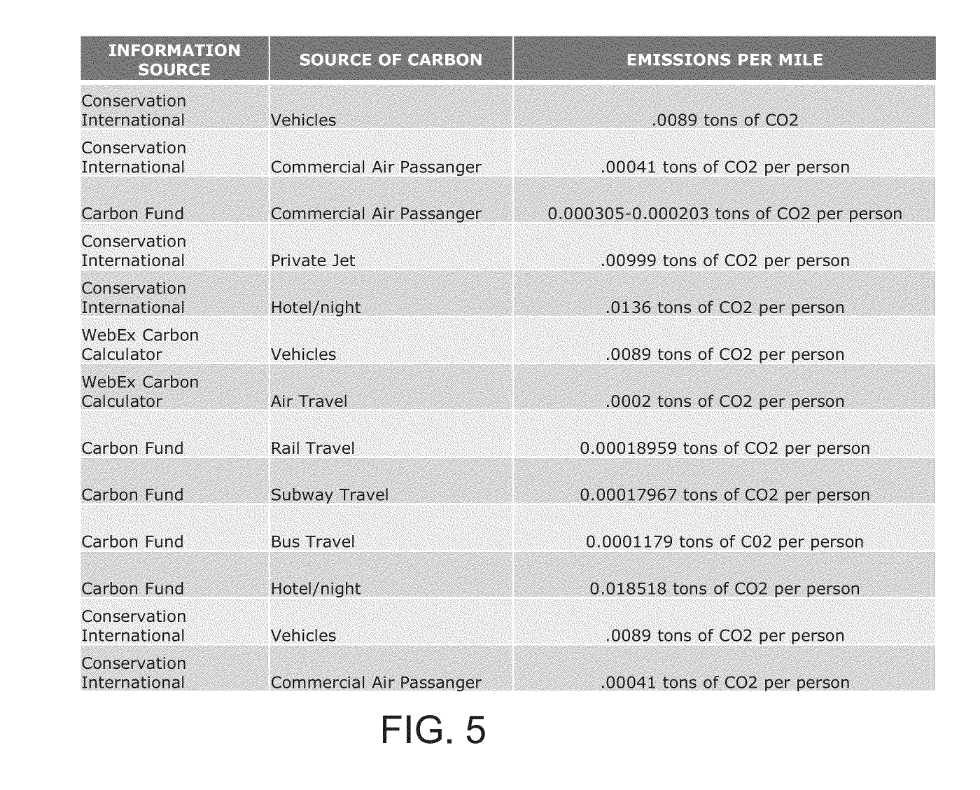

FIG. 5 is table of example carbon emissions provided by various sources across different trip-related services, according to an embodiment of the invention. The data in the table of FIG. 5 may be retrieved from various sources and stored in the database for use in computing the carbon offset of a trip. The first column of the table in FIG. 5 shows the source of the information. The second column indicates the kind of carbon source such as transportation, lodging, food, etc. Most of the information in the example tables provides carbon footprint for modes of transportation, but restaurants, lodging stays and other activities may be listed here as well.

External Payment System 260: FIG. 3 is an screen shot of a stand-alone web page for donating money to a non-profit organization whose work removes greenhouse gasses from the environment. However, this web page and those like it do not help determine how much to donate based on the carbon impact of a trip. Some other websites might help determine only a transportation carbon impact, but does not include the impact of other components of a trip.

In an embodiment, the trip planner may link directly to an established site such as the one shown in FIG. 3. In another embodiment, the trip planner may connect to and interact with an external payment system 260 for processing a credit card payments. A traveler may interact with an online payment system outsourced by a third party to deposit money in a traveler's trip planning account. The trip planning application may then transfer funds from the travelers' account to one of at least two destinations: 1) the money may be transferred directly from the traveller's account to the selected organizations providing carbon emissions offsets or 2) traveller's donations may be placed in a pool of donations to be given to the selected organization. Payments to the selected organizations may be made on a regular recurring basis. Having control over the master account or individual traveler accounts allow the host/operator of the framework to switch to paying different projects/orgs with allows us to find the best partners each year.

### Taking Instrumentation on the Road

Energy consumption information may be received by sensors in a stationary setting such as a home or business through wireless communication. Places may be instrumented to produce data in response to an individual interacting with the environment. For example, when a traveler checks into a hotel, the traveler may register with the hotel energy consumption interface. The sensors may detect the amount of electricity and hot water used in the traveler's room, and such data may be collected and provided to the traveler for inclusion in their itinerary.

### Estimating Carbon Impact

The carbon footprint estimates are based on heuristics and some related data regarding the eco-impact of an activity.

The system may be built so that modules are plug replaceable as more information becomes available. For example, first embodiments may use a common carbon footprint estimate for eating any meal in any restaurant anywhere. Later embodiments may provide more accurate, fine-grained estimates. For example, the carbon footprint estimate may vary between a steak houses and a vegetarian restaurant, assigning a higher carbon footprint to eating in the steak house. Another example is that a different carbon footprint may be associated with eating dinner rather than breakfast. Finer grained considerations for a restaurant's carbon impact may consider eco-friendly practices such as only providing water when requested, providing small portions, using locally grown food (lowers fuel for transportation costs to the restaurant), reusing grease, or contributing compost back to a local farm. In an embodiment, the specific meal that you order may have a carbon impact associated with it that is distinguished from a different meal. For example, the carbon impact of ordering a barbecued steak may be higher than that of a raw salad.

Estimating the carbon impact of a mode of transportation such as walking, biking, automobile, bus, train, airplane, cruise ship, etc. may be determined based on the distance travelled. In an embodiment, all airline trips of a certain length may use the same carbon footprint estimate, whereas in another embodiment, different types of aircraft, how many stops are made along the route, the temperature of the locations travelled through, etc. may affect the actual carbon footprint, and may be taken into account in the carbon impact estimate.

The carbon impact for a hotel stay may be estimated as the same value for any hotel anywhere. In other embodiments, carbon impact could be differentiated based on brand/chains based on validated eco-friendly or eco- un-friendly practices, size of room, season of the stay, etc. In an embodiment, a trusted authority may assess a hotel's eco-related practices including but not limited to: use of recycled material in building construction, use of solar electricity or solar hot water heating, providing recycling bins for guest to deposit all recyclable materials, encouraging guests to use towels and sheets more than once to reduce energy used for laundry, and use of hotel cards to enable electricity in a room such that electrical appliance are not left on when leaving the hotel with the key.

### Verifiable Source of Information for Carbon Footprint Data.

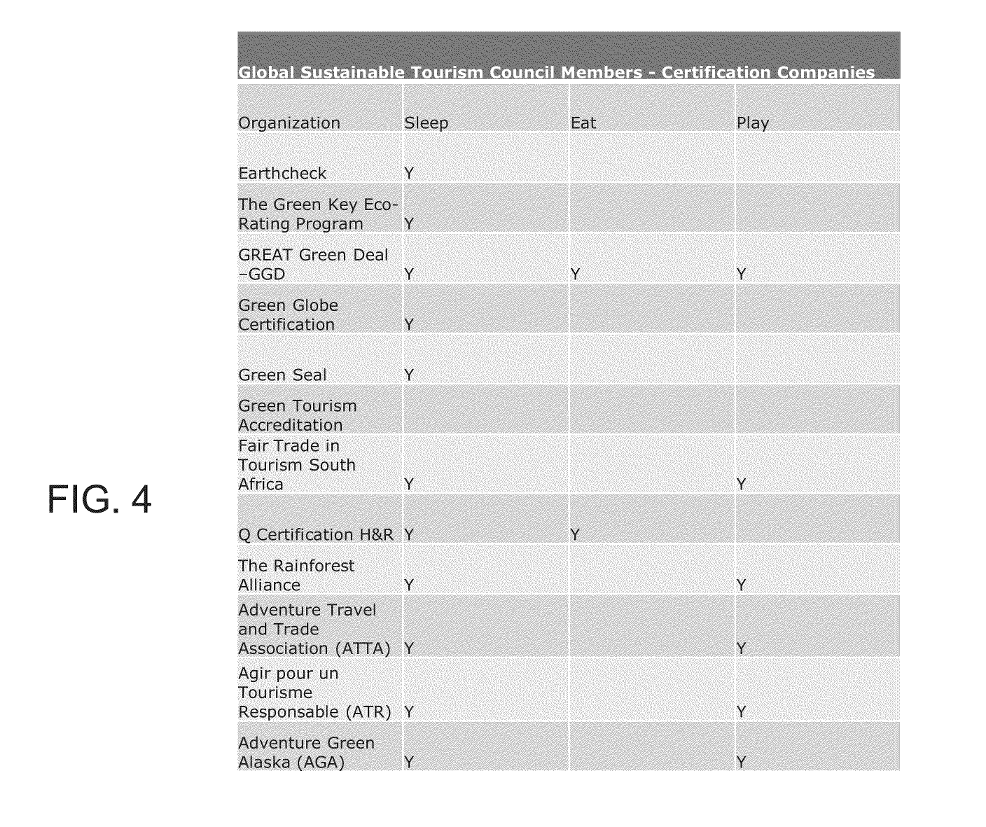

FIG. 4 shows at least a partial list of companies that certify trip-related services for sustainability. Such certification ensures that the data collected and used to estimate carbon impact has been audited and can be trusted. FIG. 4 shows organizations that audit Sleep (lodging), Eat (meals), and Play (recreation).

### Example Trip Scenarios

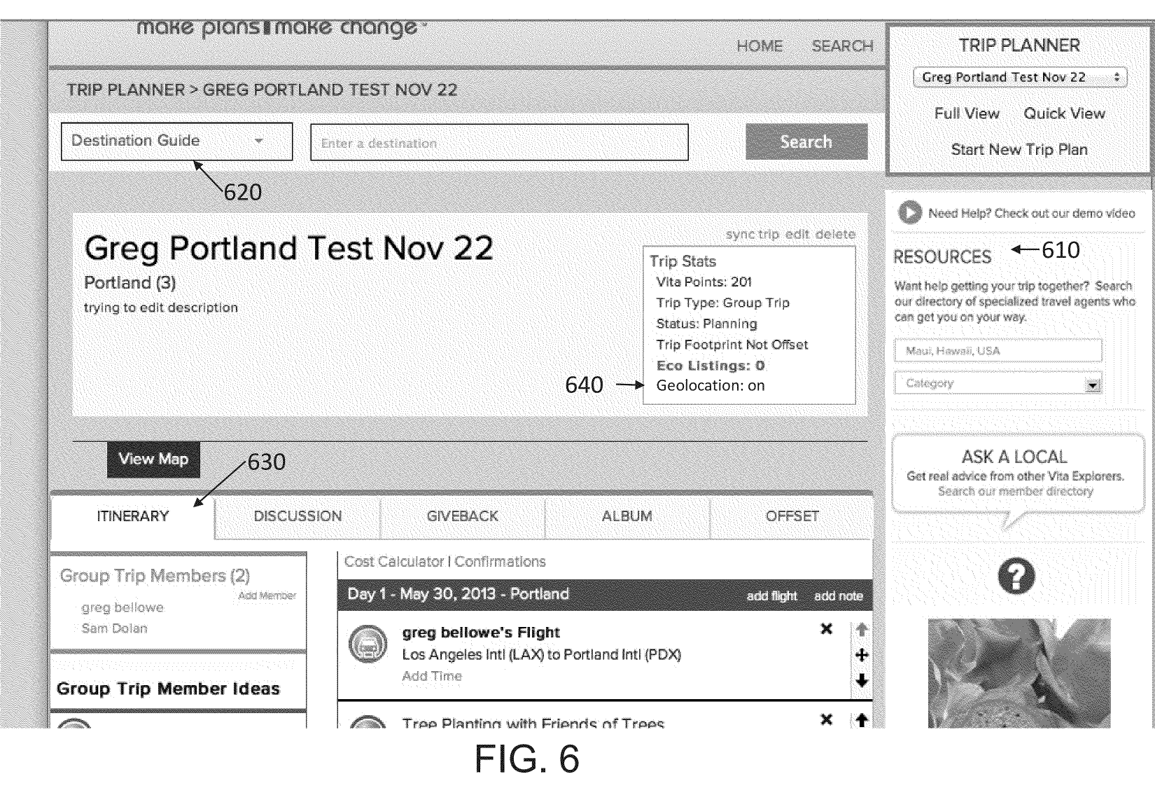

A user of the Trip Planner interface may use resources on the page or website or printed guidebook to research trip destinations. FIG. 6 shows a primary page for the Trip Planner, according to an embodiment of the invention. Resources 610 such as for finding specialized travel agents and a trip destination guide 620 shown in FIG. 6 are two examples of resources provided for trip planning. The user may start to plan a trip by selecting a destination (and other criteria through several previous steps/pages, such as number of travelers and dates of trip or number of days in trip), then search for trip ideas through the websites “Search” section and then start adding itinerary events in the Itinerary Tab 630. The Trip Stats box displays configuration information associated with the current trip. For example, a geo-location configuration 640 may be turned on or off. When turned on, the trip planner may receive location information that is generated in real-time and sent to the trip planning system by a traveler's mobile device. When turned off, the trip planner does not expect to receive such real-time location information.

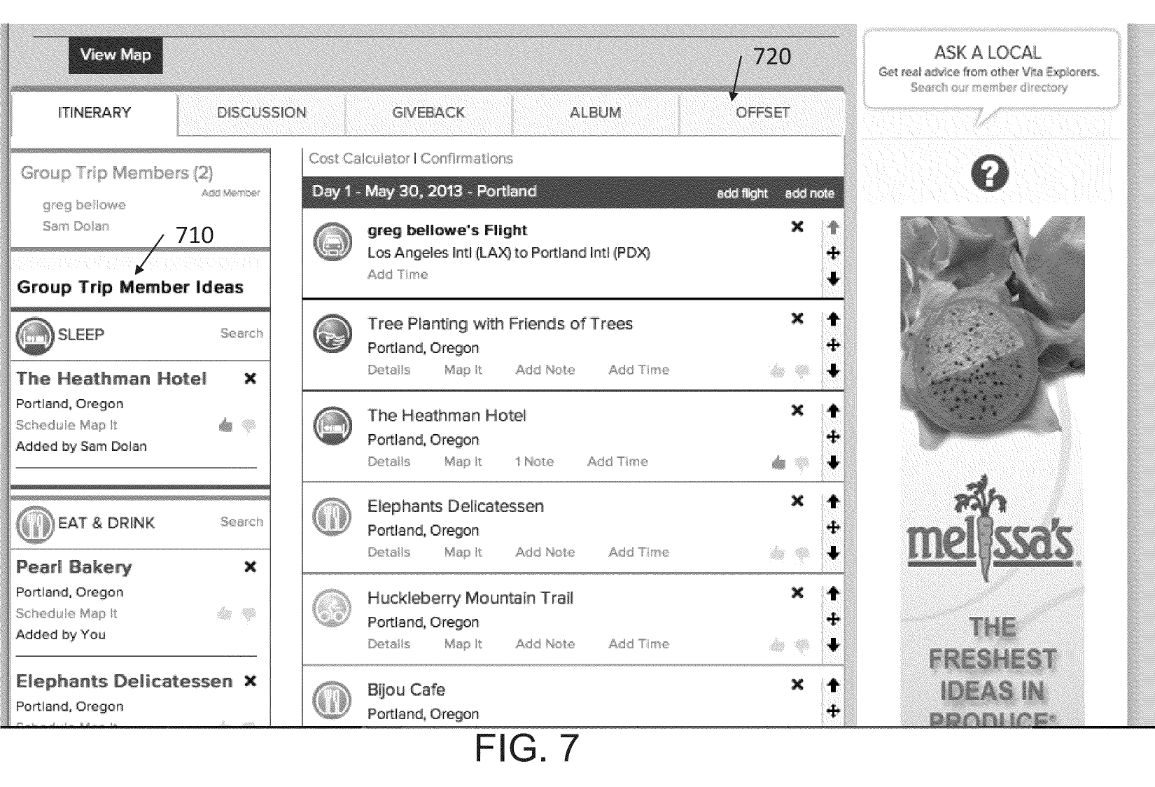

The example itinerary shown in FIG. 6 is a trip from Los Angeles to Portland planned for Greg Bellowe. FIG. 7 shows more itinerary events in the itinerary tab, according to an embodiment of the invention. For example, on May 30, 2013, Greg plans to fly from LAX to Portland International airport. In Portland, Greg will stay at the Heathman hotel and eat at the Elephants Delicatessen and the Bijou Café. Greg plans to bicycle on the Huckleberry Mountain Trail and attend a tree planting activity. Icons next to each itinerary event correspond to the category of the event such as transportation, lodging, food, a type of activity such as biking, or a “giveback” activity having a negative carbon impact/offset (i.e. the open hand symbol).

The Group Trip Member Ideas 710 on the left side of the page offers suggestions of resources relevant to the selected destinations and categories for potential selection for the trip itinerary.

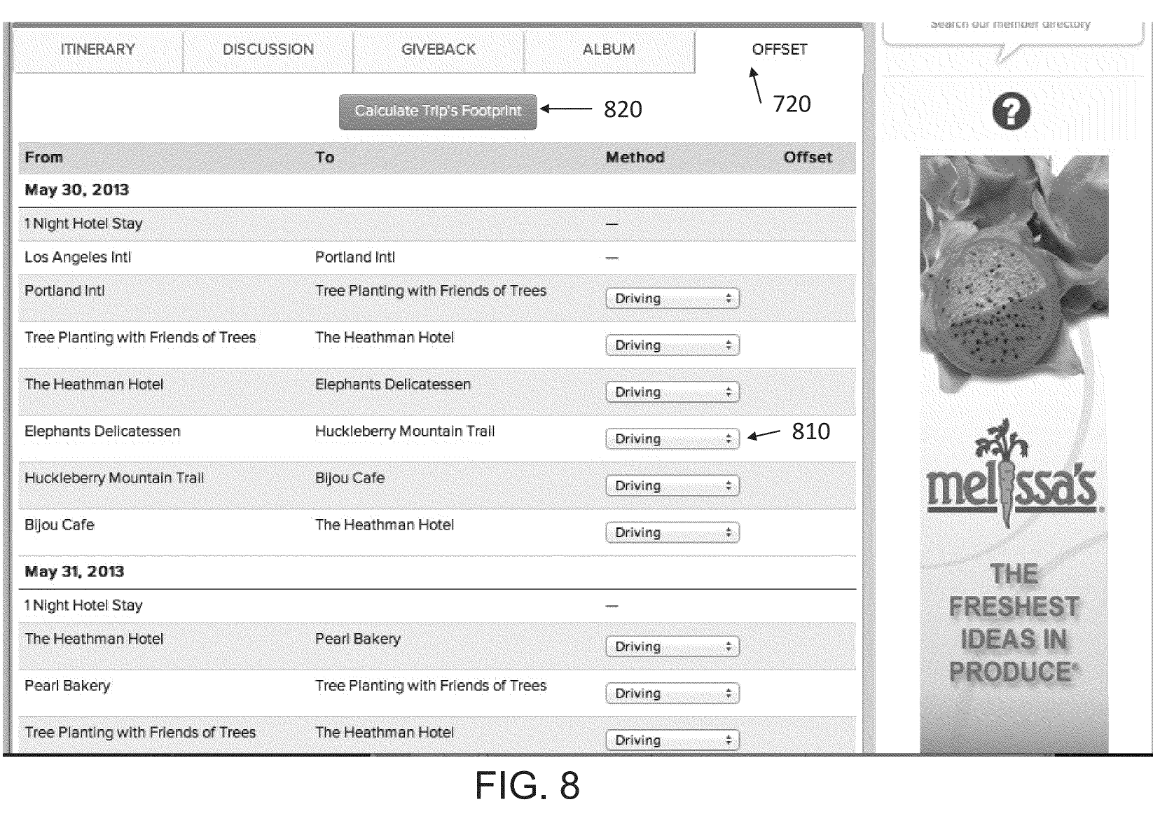

Once the trip itinerary is planned, the user may select the Offset tab 720. Example contents of the Offset tab 720 is shown in FIG. 8, according to an embodiment of the invention. For each transportation-related event, the user may select a transportation type such as driving, taking the train, walking, etc. The type of an explicit transportation event, such as flying from LA to Portland, is already known to the system. In the example, once Greg arrives in Portland, he drives from one activity to the next. For example, Greg drives from the Elephants Delicatessen to the start of the bike trail (see itinerary event 810). When the user selects the Calculate Trip's Footprint button 820, the trip planner automatically calculates distances between the starting location and ending location of each itinerary event, and based on the distance and the transportation type, determines the carbon footprint for the transportation portion of each itinerary event. The trip planner also looks up the carbon impact of other kinds of activities such as lodging and food. Certain giveback activities may be associated with a negative carbon footprint that may offset the carbon footprint of the trip before calculating a monetary offset amount. However, this may be supported only by activities sponsored by organizations that can quantify the amount of giveback associated with your completed activity and its effect on improving the environment. For example, planting a tree or participating in a coastal or river cleanup may provide a credit that may reduce the environmental impact of an overall trip.

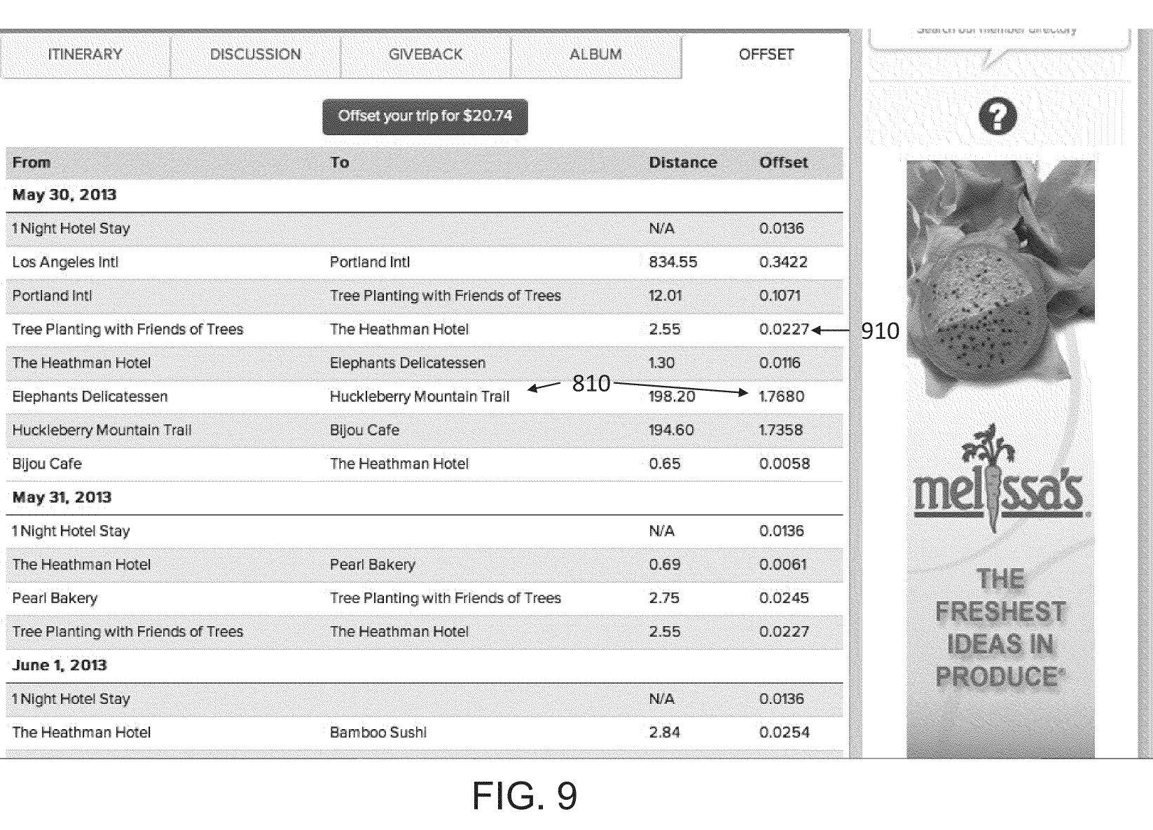

FIG. 9 shows example contents of the offset tab after calculating the carbon offsets, according to an embodiment of the invention. For example, for itinerary event 810, the drive from the Elephants Delicatessen to the Huckleberry Mountain Trail is 198.2 miles, having a carbon footprint of 1.7680. The flight from LAX to Portland is a distance of 834.55 miles requiring an offset of 3422. A one night hotel stay at the Heathman Hotel on May 30 (see 910) is determined to require an offset for 0.0227 units of carbon footprint that includes the transportation to travel from Tree Planting with Friends of Trees as well as the carbon footprint of the night's lodging at the hotel (0.0136 which is seen in the first line item for each day). In an embodiment, one unit of carbon footprint may represent one ton of carbon dioxide released into the atmosphere.

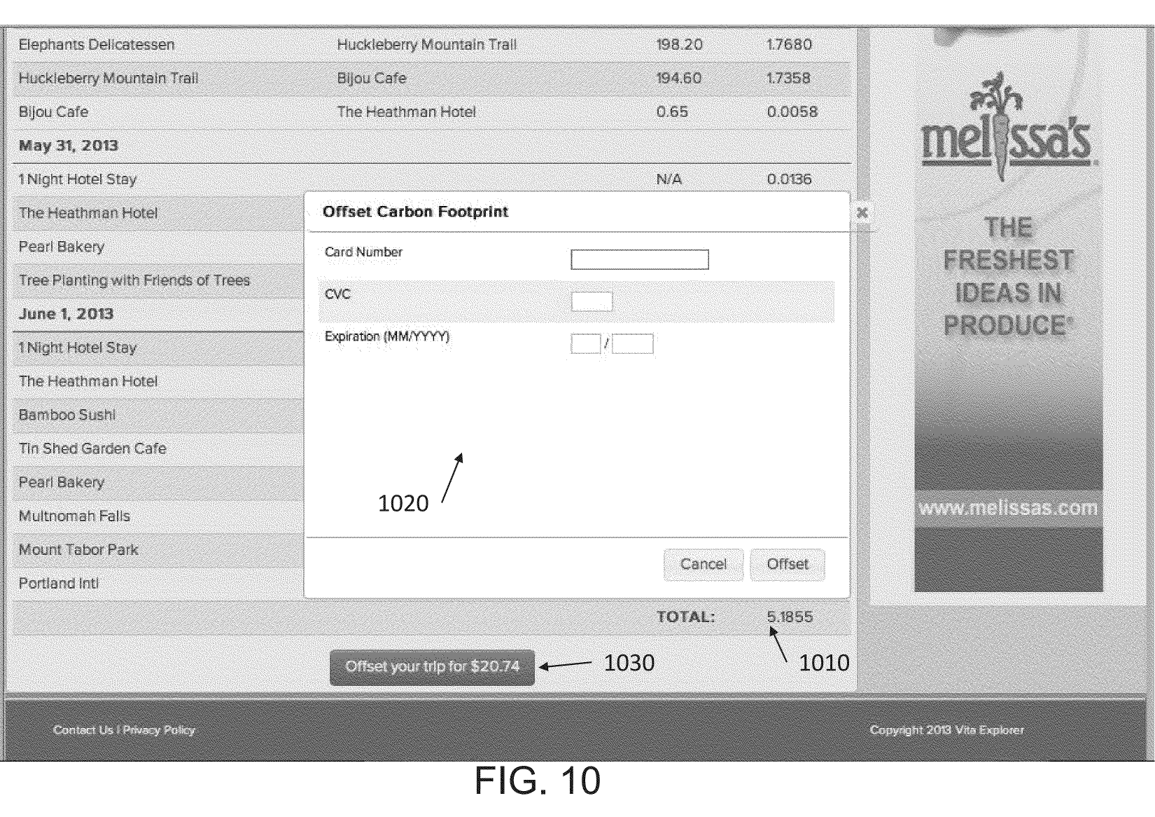

FIG. 10 is an example screenshot showing the totals for the units of carbon offsets required to offset all activities of the entire trip, according to an embodiment of the invention. In this example, a total of 5.1855 units is needed to offset the example itinerary (see 1010). A configured price per unit of carbon offset configured into the tool is used to determine the amount of money needed to offset the carbon footprint. In the example, the tool determines that $20.74 is needed (see 1030). When the user selects the Offset your trip for $20.74 button, a form may be provided for supplying credit card information for paying the $20.74, according to an embodiment of the invention (see 1020). When the user types in a credit card number which is authorized, the trip offset amount may be deposited into the user's trip planner account which may be funneled to one or more selected not-for-profit organizations that work to reduce greenhouse gases in the atmosphere, for example Nature Conservancy or another not-for-profit that plants trees.

As mentioned earlier, the offset need not be paid at the planning stage. The user may update the itinerary to reflect changes in the actual trip that may deviate from the original plan. The user may wait until the trip concludes, update the trip itinerary, and then pay to offset the actual carbon footprint of the trip rather than the planned footprint. The user may use the trip planner multiple times throughout a period of time (e.g. for a year) and not offset any trips. The trip planner keeps track of each trips footprint and shows the total environmental impact for all trips and what has /has not been offset. The user can decide to offset all his/her trips footprints at one time in one transaction such as at the end of the year.

Placeholders in the planned itinerary may be allocated for an anticipated meal even if the particular restaurant is not known in advance. Actual specific information about a meal may or may not be added to the itinerary during or after the trip.

In an embodiment of the invention, upon returning from the trip, the traveler may be prompted to pay for the total estimated carbon impact of the trip based on the most specific information supplied in the itinerary.

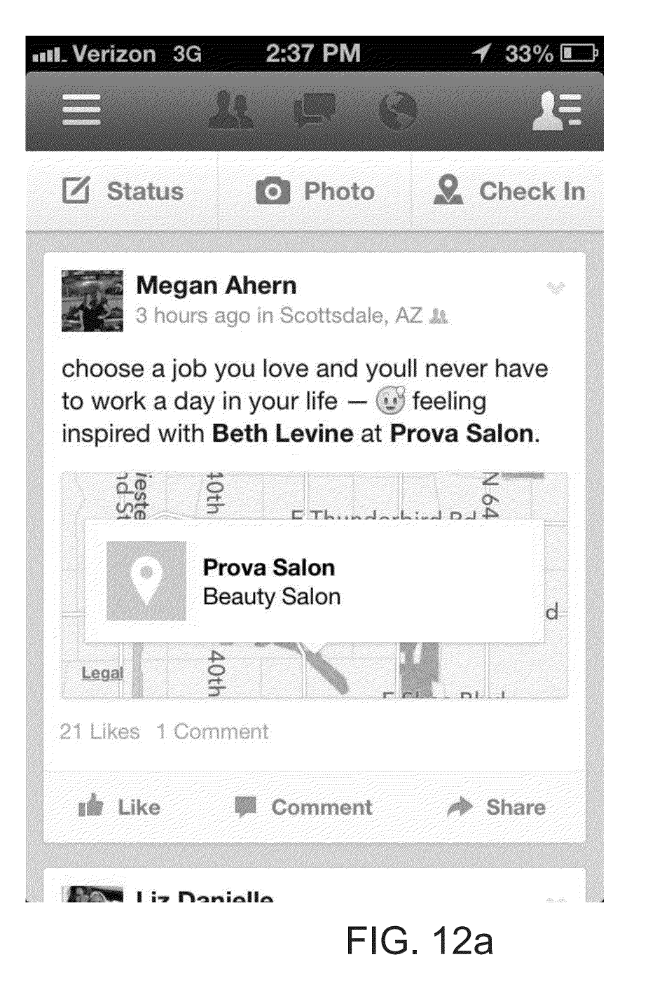

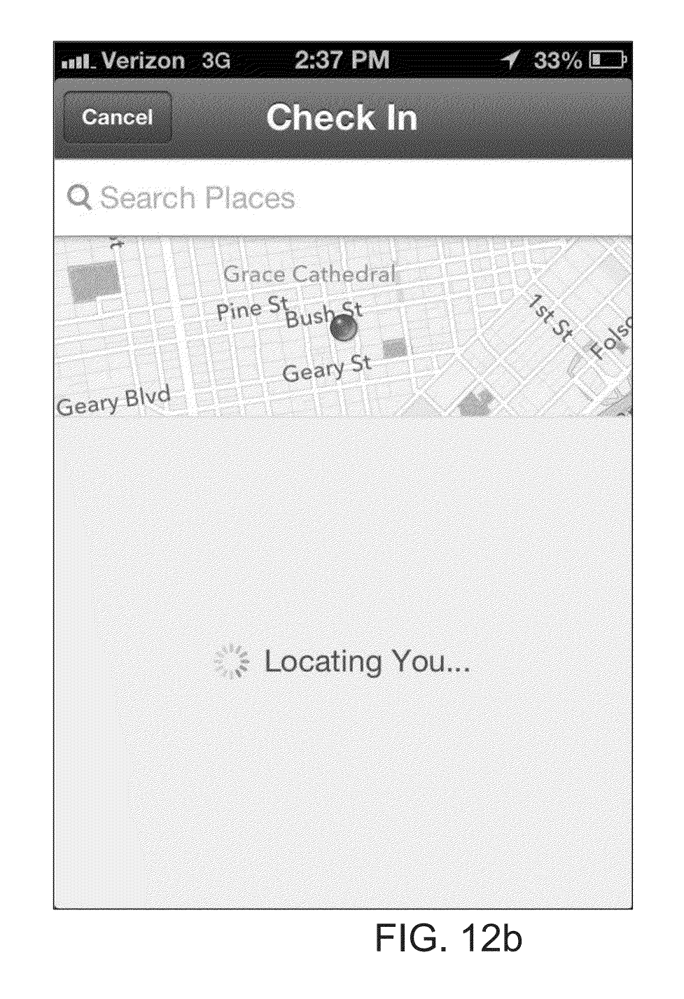

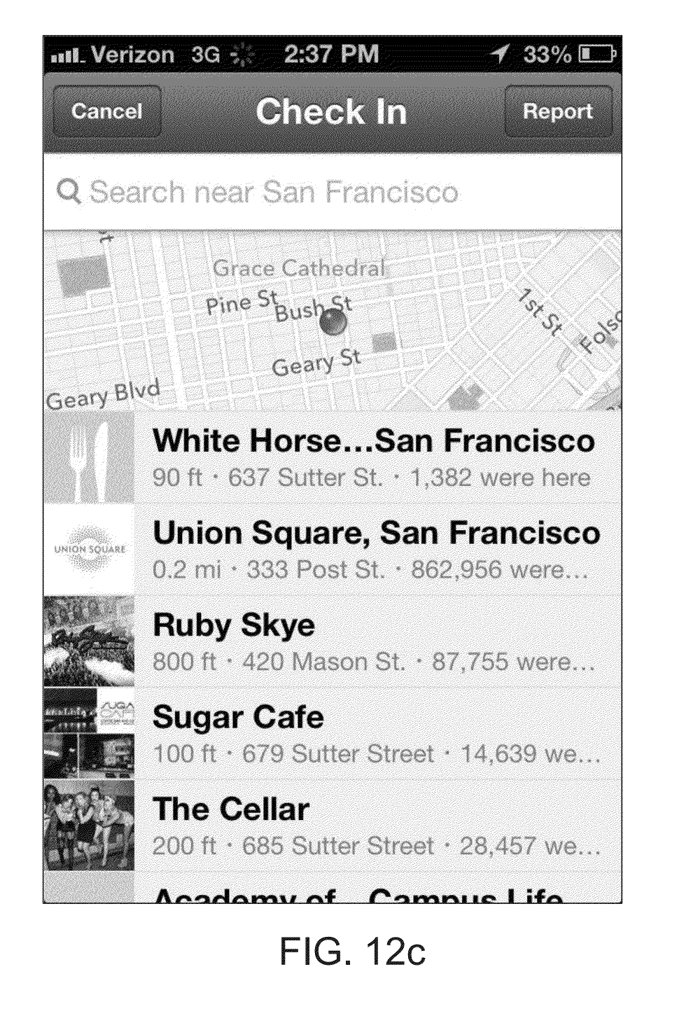

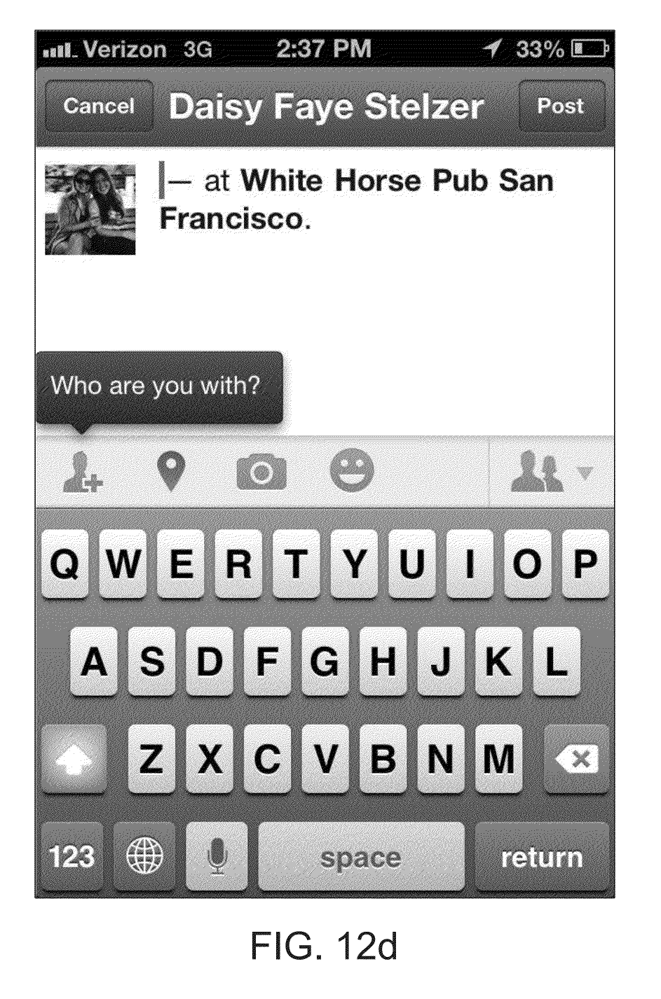

Updating a planned itinerary with actual completed trip information may be done in several different ways. In an embodiment, the traveler may use an application on their mobile device, such as Facebook on a mobile phone, to indicate where they are, when they are there, and any comments. Trip planner system integration with the mobile application such as Facebook may retrieve this check in information and compare it to the trip itinerary. FIG. 12a is a screen shot of an example mobile application that allows check in, according to an embodiment of the invention. The profile page of traveler is shown on the display of the traveler's mobile device, on which it can be seen that the traveler's friend, Megan Ahern, has checked in at the Prova Salon. The traveler may check into her current location by selecting the “Check In” link in the top right corner of the screen. Upon selecting “Check In,” the display changes to what is seen in FIG. 12b. FIG. 12b is a screen shot of a mobile device updating the screen with a map of the vicinity of the traveler, and an indication of where on that map the traveler is currently located, according to an embodiment of the invention. When the map is completely displayed, the application also provides a list of businesses of potential interest to the traveler that are close to the traveler's location such as seen in the example screen shot of FIG. 12c, according to an embodiment of the invention. For example, the White Horse restaurant and the Skye café are nearby. The traveler is also near a point of interest, Union Square. If the traveler selects the White Horse restaurant entry, the mobile application can pre-populate a posting including the location and name of the restaurant, and allow the traveler to add notes. When finished, the information may be posted on a social media bulletin board, and the trip planner system may receive check in information for the White Horse restaurant. If a meal at the White Horse restaurant is in the itinerary, the trip planning system may update the trip progress with an indication that this portion of the trip has been completed. If the White Horse restaurant is not on the itinerary, the trip planning system can create a new itinerary entry for the White Horse, determine and record the destination of the White Horse restaurant from the previous check in location, and update the next segment of the trip with the estimated distance between the White Horse restaurant and the next expected check in point. In an embodiment of the invention, if the next expected destination is a restaurant, the trip planning system may prompt the user to choose whether the White Horse restaurant should replace the previous restaurant itinerary entry or simply be added to the itinerary.

An embodiment in which a traveler checks into locations of interest may be useful for offsetting a trip for which there is no pre-planned itinerary. The act of checking in provides the trip planning system with the location and type/category of itinerary item from which to construct very basic a retrospective itinerary.

In another embodiment, the trip planner may be used in conjunction with a mobile application that proactively provides traveler information periodically without the traveler having to check in. This embodiment minimizes the amount of traveler interaction required to determine the carbon offset of the trip. With the trip geo-location configuration option 640 turned on and the traveler's mobile device enabled to broadcast or respond to a request for information regarding the device's location, the trip planning system may receive steady stream of traveler location data over time. The trip planner can use this information to identify the travel route and stopping points. If a pre-planned itinerary exists, then when the location of the traveler comes within a threshold distance of the location of an itinerary event, the traveler may be automatically checked in, or prompted to confirm check in. For example, if the traveler Daisy had been planning to visit Union Square, the trip planner may automatically determine that the trip to Union Square has completed, or the system may prompt Daisy to confirm that she has, in fact, arrived at Union Square.

In another embodiment in which there is a pre-planned itinerary that will be followed closely, a mobile device need not be enabled for providing location information. This embodiment is advantageous for those who do not want their location to be continually tracked. Instead, the trip planner may send a prompt to the traveler's mobile device, with which the traveler interacts with (clicks, touches, responds to, etc.) to check into the next itinerary event. For example, referring to Greg Bellow's itinerary in FIG. 7, once Greg checks in to his flight at the airport, the trip planning system may send a prompt, which when responded to, may check Greg in at “Tree Planting with Friends of Trees.” Once checked into the tree planning activity, the trip planning system may generate a new prompt for checking into the Heathman hotel. Such an embodiment may be, but is not required to be, integrated with another third party application.

Regardless of how check in occurs, the traveler may be prompted to provide the trip planning system with supplemental information that the system cannot infer automatically. For example, using geo-location, the system may not be able to tell which of several businesses in the area are the intended check in location. However, with technological advances in which mobile devices are becoming more contextually aware, the mobile device may sense that the traveler is in a restaurant, a park, a theater, etc. and this contextual information may be used to help disambiguate among business and used to select a check-in destination among co-located business.

The view of the trip planning itinerary may change as a result of checking in. For example, continuing to refer to FIG. 7, the icon representing a particular itinerary entry may be displayed as faded (e.g. grayed out) once the trip is underway, but displayed sharp and bold upon checking into that event. Alternatively, any visual indicator may be provided in each itinerary entry, such as a light that illuminates or a box that is checked, when the traveler checks into an event. In addition, if geo-location is enabled, the actual distance travelled may be updated in the Offsets screen. Although not explicitly shown in FIG. 9, the distance column may be updated with the actual distance travelled, and a visual indicator, such as the use of color, may identify the distance reported as representing either estimated or actual distances. Alternatively, a separate column may be provided with the actual distance travelled.

Upon returning home, the actual itinerary may be completely or only partially filled out. The traveler may use the trip planning tool to supply any additional detailed information for making the estimated carbon impact of the trip more accurate.

### An Example Machine Overview

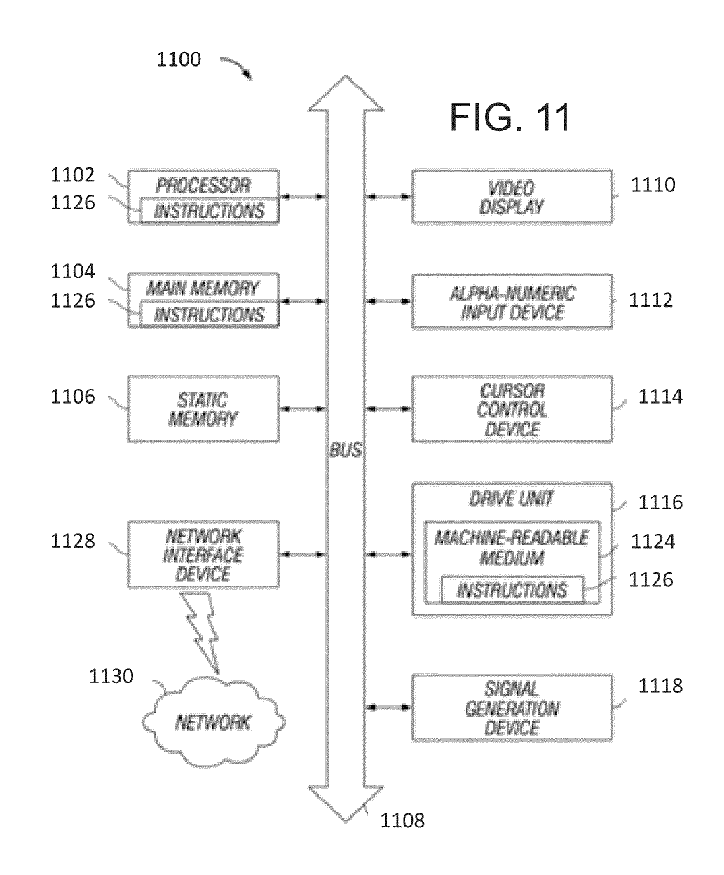

FIG. 11 is a block schematic diagram of a machine in the exemplary form of a computer system 1100 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 1100 includes a processor 1102, a main memory 1104 and a static memory 1106, which communicate with each other via a bus 1108. The computer system 1100 may further include a display unit 1110, for example, a liquid crystal display (LCD) or a cathode ray tube (CRT). The computer system 1100 also includes an alphanumeric input device 1112, for example, a keyboard; a cursor control device 1114, for example, a mouse; a disk drive unit 1116, a signal generation device 1118, for example, a speaker, and a network interface device 1128.

The disk drive unit 1116 includes a machine-readable medium 1124 on which is stored a set of executable instructions, i.e. software, 1126 embodying any one, or all, of the methodologies described herein below. The software 1126 is also shown to reside, completely or at least partially, within the main memory 1104 and/or within the processor 1102. The software 1126 may further be transmitted or received over a network 1130 by means of a network interface device 1128.

In contrast to the system 1100 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

1. A computer-implemented method for offsetting an environmental impact of a trip comprising:
receiving a plurality of events associated with a trip itinerary for the trip;
automatically quantifying an environmental impact for each event of the plurality of events in the trip itinerary;
wherein said each event of the plurality of events comprises at least one of these types of activities: transportation, lodging, meals, and recreation;
where at least two events in the trip itinerary comprise different types of activities;
automatically determining a total environmental impact representing the sum of the environmental impact for all of said each event;
determining a monetary value associated with the total environmental impact;
accepting payment for the monetary value;
accepting one or more selections of environmental organizations; and
directing the payment to the one or more selected organizations.

2. The method of claim 1, wherein the environmental impact comprises one of carbon footprint, water pollution, air pollution, or landfill contribution;
wherein the carbon footprint impact is a measure representing the amount of carbon emission associated with a set of events;
wherein the water pollution impact is a measure representing the reduction of remaining potable water;
wherein the air pollution impact is a combined measure of particulates and ozone-depleting substances released into the air; and
wherein the landfill contribution impact is a measure of the amount of garbage that is sent to a landfill.

3. The method of claim 2, wherein the environmental impact comprises a carbon footprint.

4. The method of claim 1, wherein the activity types of at least two events in the trip itinerary include meals and recreation.

5. The method of claim 1, wherein a plurality of events in the trip itinerary comprise transportation; and
the plurality of transportation events on the trip itinerary includes at least two distinct modes of transportation including driving, flying, and taking a train.

6. The method of claim 1, wherein receiving the plurality of events associated with an itinerary for the trip further comprises:
a traveler, using a user interface on a mobile device, to specify each event; and
the traveler engaging in one or more events of the plurality of events associated with the trip itinerary;
determining that an event has been completed;
wherein the determining is based on receiving location information about the traveler from said mobile device.

7. The method of claim 6, wherein determining that an event has been completed is performed automatically without a human interacting with the user interface on the mobile device.

8. The method of claim 7, wherein automatically determining that an event has been completed further comprises receiving location information associated with each event in the itinerary; and
comparing the traveler's location to the location of said each event.

9. The method of claim 6, wherein determining that an event has been completed comprises the traveler interacting with the user interface of an application running on the mobile device.

10. An apparatus for compensating for environmental impact associated with a trip comprising:
An input device coupled to a processor for receiving a plurality of events associated with a trip itinerary for the trip;
a storage module coupled to the processor for looking up a quantity of environmental impact for each event of the plurality of events in the trip itinerary;
wherein the storage module stores environmental impact data for at least all of these types of activities: transportation, lodging, meals, and recreation;
where at least two events in the trip itinerary are different types of activities;
the processor computing a total environmental impact representing the sum of the environmental impact for all of said each event;
the processor computing a monetary value associated with the total environmental impact;
the input device configured to receive payment information for the monetary value;
the input device accepting one or more selections of environmental organizations; and
a network interface coupled to the processor wherein the payment information is directed to the one or more selected organization through the network interface.

11. The apparatus of claim 10, wherein the apparatus is a mobile phone.

12. The apparatus of claim 10, wherein the apparatus is a wearable computer and is one of: a watch, eye glasses, or clothing.

13. The apparatus of claim 10, wherein the apparatus is one of a tablet, laptop computer, desktop computer, or public kiosk.

14. The apparatus of claim 10, wherein the environmental impact comprises one of carbon footprint, water pollution, air pollution, or landfill contribution;
wherein the carbon footprint impact is a measure representing the amount of carbon emission associated with a set of events;
wherein the water pollution impact is a measure representing the reduction of remaining potable water;
wherein the air pollution impact is a combined measure of particulates and ozone-depleting substances released into the air; and
wherein the landfill contribution impact is a measure of the amount of garbage that is sent to a landfill.

15. The apparatus of claim 14, wherein the environmental impact comprises a carbon footprint.

16. The apparatus of claim 10, wherein the activity types of at least two events in the trip itinerary include meals and recreation.

17. The apparatus of claim 10, wherein a plurality of events in the trip itinerary comprise transportation; and
the plurality of transportation events on the trip itinerary includes at least two distinct modes of transportation including driving, flying, and taking a train.

18. The apparatus of claim 10, further comprising:
a location detection unit coupled to the processor;
the location detection unit configured to determine the location of the apparatus;
the processor configured to receive the location of the apparatus;
the processor configured to determine that an event has completed based on the location of the apparatus.

19. The method of claim 18, wherein the user input device is further configured to receive input from the traveler;
the processor further configured to determine, in response to the input from the traveler, that the traveler has been completed an event.

20. The method of claim 18, wherein the location detection unit comprises Global Positioning System (GPS).
